(19) United States
(12) Patent Application Publication
(10) Pub. No.: US 2023/0236152 A1
(43) Pub. Date: Jul. 27, 2023

(54) ACOUSTIC RESONANCE FLUID FLOW MEASUREMENT DEVICE AND METHOD

(71) Applicant: FT Technologies (UK) Ltd, Sunbury-on-Thames (GB)

(72) Inventors: Javier CASTILLO, Sunbury-on-Thames (GB); Sotiris SOTIROPOULOS, Sunbury-on-Thames (GB)

(21) Appl. No.: 18/029,895

(22) PCT Filed: Sep. 9, 2021
(86) PCT No.: PCT/GB2021/052335

§ 371 Date: Mar. 31, 2023

(30) Foreign Application Priority Data
Oct. 1, 2020 (GB) 2015619.6

(51) Int. Cl. G01N 29/036; G01N 29/22

(52) U.S. Cl. CPC G01N 29/036; G01N 29/222; G01N 2291/014

(57) ABSTRACT

A method of operating an acoustic resonance fluid flow sensor. The method comprises emitting an acoustic stimulus signal comprising a plurality of frequencies into an acoustic resonance cavity of the acoustic resonance fluid flow sensor, sensing an acoustic response signal within the acoustic resonance cavity and deriving the phases or equivalent group delays of one or more frequency components of a frequency spectrum of the acoustic response signal.

### FIELD OF THE INVENTION

The present invention relates to methods and systems for operating an acoustic resonance fluid flow sensor, such as an acoustic resonance anemometer, and sensors configured to operate according to such methods.

### BACKGROUND TO THE INVENTION

Acoustic resonance anemometers, such as those described in European Patent EP0801311, operate by generating acoustic waves within a cavity at a resonant frequency and measuring phase shifts (or equivalent time delays) therein. The resonant frequency of such anemometers varies, for example with changing air temperature; this can result in the amplitude of waves generated within the cavity falling unless the frequency at which the acoustic wave is generated is adjusted to match the changing resonant frequency of the cavity.

An aim of the present invention is to provide improved methods and systems for operating acoustic resonance fluid flow sensors such as acoustic resonance anemometers.

### SUMMARY OF THE INVENTION

According to a an embodiment of the invention, there is provided a method of identifying a resonant frequency of an acoustic resonance fluid flow sensor, the method comprising: emitting an acoustic stimulus signal comprising a plurality of frequencies into an acoustic resonance cavity of the acoustic resonance fluid flow sensor; sensing an acoustic response signal within the acoustic resonance cavity; and identifying a frequency of the peak in a frequency spectrum of the acoustic response signal.

This method may advantageously enable a plurality of frequencies to be checked for a resonant frequency simultaneously. In this manner a snapshot of the frequency characterisitcs of the acoustic resonance cavity is obtained. This may significantly reduce the time required to and increase the accuracy of identifying a resonant frequency of an acoustic resonance fluid flow sensor, for example in comparison to methods involving a large number of single frequency measurements. The method may further comprise deriving the phases or equivalent group delays of one or more frequency components of a frequency spectrum of the acoustic response signal, these one or more frequency components preferably including the identified peak frequency component.

The method may comprise deriving a phase or group delay of the sensed acoustic response signal at the identified frequency of the peak and determining a speed of fluid flow through the sensor based on the derived phase or group delay.

This method may advantageously enable, facilitate or improve measurements of speeds of fluids flowing through the acoustic resonance cavity using the derived phases or equivalent group delays of the one or more frequency components. It will be understood that, the frequency of a resonance peak in the frequency spectrum can be determined simultaneously with the phase or group delay of one or more frequencies in the spectrum. Wind speed calculation can then be directly based on the thus determined resonance frequency and thus derived phase or group delay.

In embodiments, the plurality of frequencies is a band of frequencies. The band of frequencies is preferably a continuous band of frequencies of substantially constant amplitudes. The acoustic stimulus signal preferably comprises substantially no frequencies outside the band of frequencies. Preferably, all frequencies of the acoustic stimulus signal outside the band have substantially zero amplitude, and/or all frequencies within the band preferably have substantially equal amplitude. The acoustic stimulus signal may therefore define a substantially rectangular, or boxcar function, profile in the frequency domain. Alternatively, the plurality of frequencies may be a plurality of distinct frequencies.

The fractional bandwidth, which is the bandwidth of the band of frequencies divided by the centre frequency of the band of frequencies, may be greater than 0.014, greater than 0.029, greater than 0.043, greater than 0.057, greater than 0.071, greater than 0.129, and/or greater than 0.229. For example, the band of frequencies may have a fractional bandwidth equal to 0.071 or 0.286. The band of frequencies centre frequency may be any frequency that the acoustic resonator may resonate, when operating as described in the European Patent EP0801311.

The band of frequencies is preferably a band of frequencies within which a resonant frequency is expected to occur. Such an expectation may be derived from or influenced by one or more previously measured resonant frequencies, the results of one or more previous iterations of the method, one or more physical characteristics of the sensor, one or more meteorological parameters, and/or one or more user inputs.

If no previous iterations of the steps of the method have been performed within a preceding time period an iteration of the steps of the method may be performed in which the band of frequencies is a pre-set or default band. Such an iteration of the method may be an initial probing measurement, and the pre-set band may be a range spanning all frequencies within which a resonant frequency is expected to occur.

In an embodiment the method further comprises determining whether a parameter of a signal quality of the sensed acoustic response signal (such as a signal to noise ratio) exceeds a predetermined threshold. If the parameter of the signal quality does not exceeds the predetermined threshold, the steps of the method are preferably repeated with the acoustic stimulus signal comprising a different plurality of frequencies.

A subsequent iteration of the steps of the method may use a narrower frequency band that comprises the frequency of an identified peak to obtain a more precise measurement of a resonant frequency, for example if the signal quality parameter is below the predetermined threshold.

If the parameter of the signal quality is below the predetermined threshold, the steps of the method may be repeated with a different band of frequencies, the different band of frequencies partially or entirely not-overlapping with the original band of frequencies.

In an embodiment, the acoustic stimulus signal comprising the plurality of frequencies is emitted by a first transducer and the the acoustic response signal is sensed using a second transducer and the method further comprises emitting a second acoustic stimulus signal comprising the plurality of frequencies into the acoustic resonance cavity using the second transducer, sensing a second acoustic response signal using the first transducer, deriving phases or group delays of one or more frequency components of a frequency spectrum of the sensed second acoustic response signal, determining a difference between the phase or group delays derived based on the second acoustic response signal and a phase or group delays derived based on the first acoustic response signal /,and determining a speed of fluid flow within the acoustic resonance cavity along an axis between the first and second using the determined difference.

The acoustic stimulus signal comprising the plurality of frequencies may be a first acoustic stimulus signal and the acoustic response signal may be a first acoustic response signal. The derived phases or group delays of one or more frequency components of the frequency spectrum of the sensed second acoustic response signal may bea phase or group delay of the sensed second acoustic response signal at the identified frequency of the peak.

According to a further embodiment, there is provided an acoustic resonance fluid flow sensor configured to identify a resonant frequency of an acoustic resonance cavity thereof, and/or to derive phases or group delays of one or more frequencies of an acoustic response signals within an acoustic cavity thereof using a method as described above.

The acoustic resonance fluid flow sensor sensor may comprise an acoustic resonance cavity; a first transducer configured to emit an acoustic stimulus signal comprising a plurality of frequencies into the acoustic resonance cavity; a second transducer configured to sense an acoustic response signal within the acoustic resonance cavity; and a signal processing means configured to: identify a frequency of a peak in a frequency spectrum of the sensed acoustic response signal. The signal processing means may be further configured to derive a phase or group delay of the sensed acoustic response signal at the identified frequency of the peak; and/or to determine a speed of fluid flow through the sensor based on the derived phase or group delay

According to another embodiment, there is provided one or more transitory and/or non-transitory storage media comprising computer instructions executable by one or more processors causing the processors to perform a method as described above.

Embodiments of the invention will now be described, by way of example, with reference to the figures.

### BRIEF DESCRIPTION OF THE DRAWINGS

FIG. 1a is an external view of an acoustic resonance anemometer;

FIG. 1b is a vertical cross sectional view of the acoustic resonance anemometer of FIG. 1a;

FIG. 1c is a horizontal cross sectional view of the acoustic resonance anemometer of FIG. 1a;

FIG. 2 is a flowchart of a method of identifying a resonant frequency of an acoustic resonance fluid flow sensor and deriving the phase shift or group delays;

FIG. 3 is a diagram of a signal generator for generating an electrical excitation signal for driving an electro-acoustic transducer comprising a range of frequencies;

FIG. 4a is a depiction of the electrical excitation signal in the time domain

FIG. 4b is a depiction of the electrical excitation signal in the frequency domain

FIG. 5a is a depiction of the electrical response signal in the time domain

FIG. 5b is a depiction of the electrical response signal in the frequency domain

FIG. 6 is a diagram of a signal processing means for analysing a electrical response signal produced by an electro acoustic transducer; and

FIG. 7 is a diagram of an acoustic resonance fluid flow sensor.

### DETAILED DESCRIPTION

Referring to the figures generally, there is shown an example of an acoustic resonance anemometer 100, as well as embodiments of anemometer operating methods 200 and anemometer components 300, 500 for identifying a resonant frequency of the anemometer and deriving a phase or equivilant group delay at this identified resonant frequency.

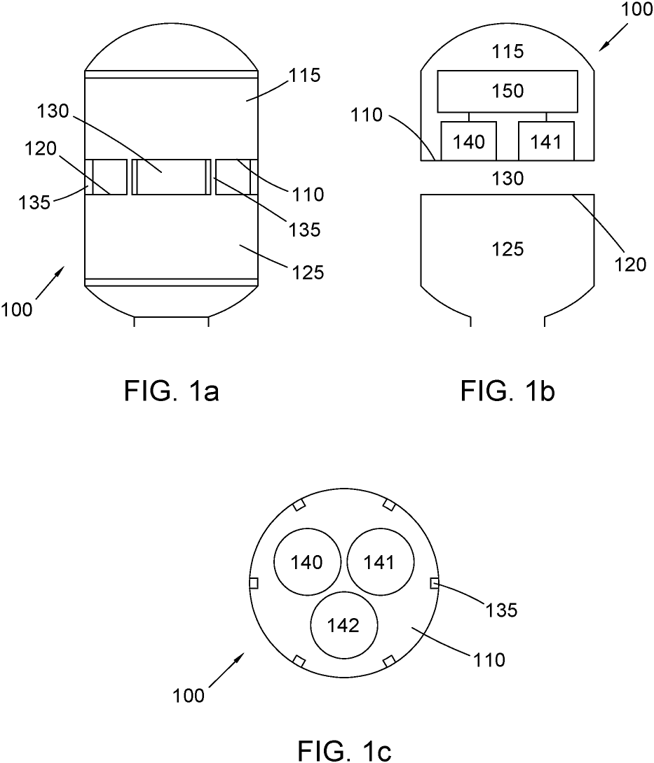

FIGS. 1a to 1c show an overall view of an embodiment of an acoustic resonance anemometer 100. The anemometer 100 comprises first and second reflector surfaces 110, 120; an acoustic resonance cavity 130 defined between the reflector surfaces 110, 120; three electro-acoustic transducers 140, 141, 142 in the first reflector surface 110; and an electronics unit 150 coupled to the electro acoustic transducers 140, 141, 142.

The anemometer 100 is generally cylindrical and comprises a first upper generally cylindrical body unit 115 and a second lower generally cylindrical body unit 125. The two body units 115, 125 are coaxial and are separated by the cavity 130, which is also generally cylindrical. The first reflector surface 110 is a substantially circular lower surface of the first body unit 115 and the second reflector surface 120 is a substantially circular upper surface of the second body unit 125. The first and second body units 115, 125 are interconnected by spacer posts 135, which extend between them near the edge of the cavity 130. In the illustrated embodiment, the posts 135 are arranged at the vertices of an imaginary hexagon normal to the longitudinal axes of the cylindrical cavity 130 and body units 115, 125.

In use, the anemometer 100 is arranged with the common axis of the cylindrical cavity 130 and body units 115, 125 substantially vertical (or otherwise orthogonal to a plane within which wind speed and direction is to be measured). The first and second reflector surfaces 110, 120 and the cavity 130 therebetween are therefore substantially horizontal (or are otherwise within a plane within which wind speed and direction is to be measured).

The anemometer 100 comprises three piezoelectric electro-acoustic transducers 140, 141, 142 in the first reflector surface 110. The electro-acoustic transducers 140, 141, 142 are arranged at the vertices of an imaginary triangle. In the illustrated embodiment, the electro-acoustic transducers 140, 141, 142 are coupled to a electronic unit within the anemometer 100. In the illustrated embodiment, the electronics unit 150 is shown within the first upper body unit 115. However, it will be appreciated that the electronic unit (or a portion thereof) may be located within the lower body unit 125 and may be connected to the electro-acoustic transducers 140, 141, 142 (and/or to portions of itself within the upper body unit 115) via electrical connections extending through one or more of the posts 135.

The transducers 140, 141, 142 have a first transmitting operating mode, in which they emit an acoustic stimulus signal in response to, and proportional to, an electrical excitation signal, thereby generating an acoustic wave within the cavity 130. The transducers further have a second receiving operating mode, in which they receive an acoustic response signal within the cavity and generate a proportional electrical response signal.

In use, one of the transducers 140 receives an electrical excitation signal from the electronics unit 150 and converts the electrical excitation signal into an ultrasonic acoustic stimulus signal, which it emits downwards into the cavity 130. If the separation between the first and second reflector surfaces 110, 120 is equal to an integer multiple of a half-wavelength of the acoustic stimulus signal, a standing acoustic wave orthogonal to the reflector plates 110, 120 is established within the cavity 130 by constructive recombination of a succession of multiple reflections of the acoustic signal between the first upper and second lower reflector surfaces 110, 120. The same wave behaves as a quasi-radial travelling acoustic wave propagating outwards in the direction parallel to the reflector surfaces 110, 120.

Acoustic resonance occurs when the frequency of the acoustic wave corresponds to a resonance frequency of the acoustic resonance cavity 130. The resonance frequencies of the cavity 130 in turn depend upon the distance separating the two reflector surfaces 110, 120 and the speed of sound in the fluid filling the cavity (typically air). The resonance frequencies of the cavity 130 therefore vary with the temperature of the fluid within the cavity 130, and to a lesser extent with the pressure and humidity of the fluid. Moreover, precipitation, or other material, accumulating on the second lower reflector surface 120 reduces the effective separation between the reflector surfaces 110, 120, thereby shifting the acoustic resonance frequencies of the cavity 130.

After an acoustic wave is generated within the acoustic resonance cavity 130 by one of the electro-acoustic transducers 140, each of the other two electro-acoustic transducers 141, 142 may receive the acoustic response signal in the cavity, converting it into a proportional electrical response signal.

In use, the phase of the electrical response signal obtained from the electro-acoustic transducer 141, 142 relative to the phase of the electrical excitation signal of the emitting transducer 140 may be derived by signal processing to obtain a phase shift estimate. The phase shift is dependent upon the time taken for the acoustic wave to travel from the emitting transducer 140 to the receiving transducer 141, 142. The speed of fluid flow within the cavity along an axis between any pair of two transducers 140, 141 may therefore be calculated from the difference in phase shift or group delay that occurs when a) transducer 140 emits and transducer 141 receives and b) transducer 141 emits and transducer 140 receives.

The velocity (speed and direction) of fluid flow within the cavity 130 in a plane parallel to the reflector plates 110, 120 may be calculated from the velocity components of fluid flow along the axes between two or three different pairs of transducers by simple trigonometry.

The fluid flow measurement device 100 is primarily for use as an anemometer measuring wind speeds. The fluid within the cavity 130 is consequently air in this use case; however, the device 100 may be useable to measure the velocities of other fluids filling the cavity.

Fluid flow speed measurements as described above are preferably performed using acoustic signals at resonant frequencies of the acoustic resonance cavity such that an acoustic standing wave is generated within the cavity. Performing the measurements at such a frequency increases their speed and accuracy, and decreases the significance of interference from other acoustic sources and of changing ambient conditions. To reliably establish the desired acoustic standing wave in the acoustic resonance cavity 130 the transducers 140, 141, 142 need to be excited at the resonance frequency of the cavity 130 prevailing at the time of measurement, and this requires knowledge of a currently prevailing resonance frequency of the cavity 130. Some known methods of identifying the resonant frequency involve sequentially emitting a series of acoustic signals, each at a single specific frequency within a band expected to include a resonant frequency (for example, between 30 and 38 kHz), measuring the amplitudes of the acoustic waves produced within the cavity by each emission of the series. By identifying the frequency at which the greatest signal amplitude is measured, the excitation frequency closest to the cavity’s resonant frequency is determined.

Embodiments described herein relate to improved methods and systems for identifying a resonant frequency of an acoustic resonance fluid flow sensor, in particular of an acoustic resonance anemometer such as the anemometer 100 described above with reference to FIG. 1.

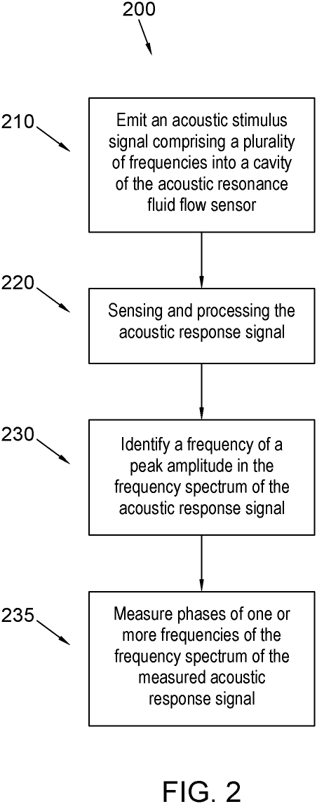

FIG. 2 is a flow chart 200 of a method of identifying a resonant frequency of an acoustic resonance fluid flow sensor, such as the illustrated anemometer 100 described above with reference to FIG. 1.

A first step 210 of the method comprises emitting an acoustic stimulus signal comprising a plurality of frequencies (such as a band of frequencies) into an acoustic resonance cavity of the fluid flow sensor. For example, emitting an acoustic stimulus signal using one of the electro-acoustic transducers 140 of the illustrated anemometer 100 into the cavity 130 thereof.

A second step 220 of the method comprises sensing an acoustic response signal within the acoustic resonance cavity. For example, sensing the acoustic response signal within the cavity using one of the two electro-acoustic transducers 141, 142 of the illustrated anemometer 100 that did not emit the acoustic stimulus signal.

A third step 230 of the method comprises identifying a frequency of a peak within the frequency spectrum of the acoustic response signal.

An optional fourth step 235 of the method comprises deriving the phases or group delays of one or more frequencies of the frequency spectrum of the sensed acoustic response signal.

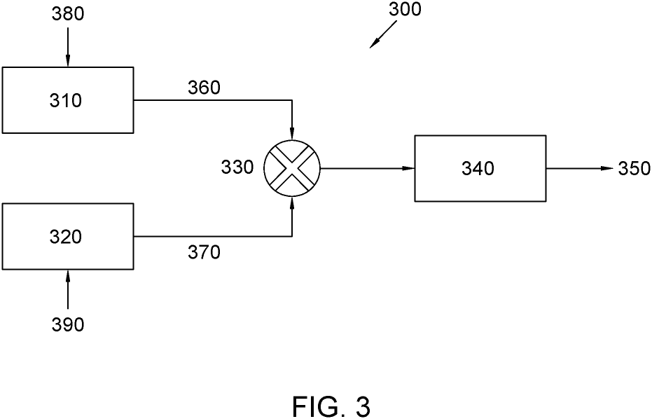

FIG. 3 is a diagram of an embodiment of a signal generator 300 for generating an electrical excitation signal to be converted into an acoustic stimulus signal by an electro-acoustic transducer, such as one of the electro-acoustic transducers 140, 141, 142 of the anemometer 100 described above. The signal generator 300 may be part of the electronics unit 150 of such an anemometer 100.

The signal generator 300 comprises a baseband signal generator 310, a carrier signal generator 320, a frequency mixer 330, modulator 340.

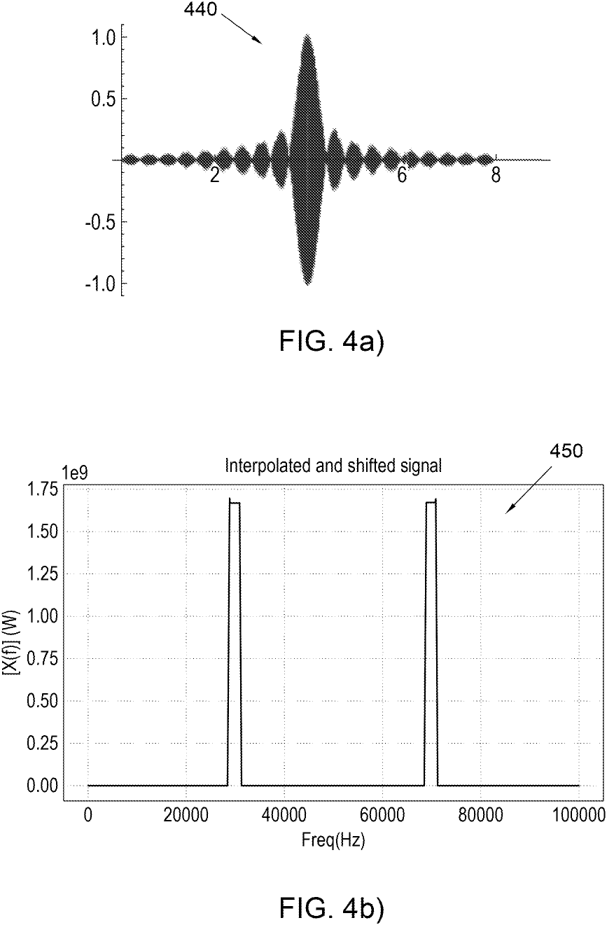

The signal generator is configured such that the electrical excitation signals 350 it generates comprise a continuous band of frequencies with substantially constant amplitude across the frequency band and substantially no frequency components outside the frequency band. The frequency band has a predetermined bandwidth and a predetermined centre frequency. Consequently, the electrical excitation signal 350 has a substantially square or boxcar shaped waveform within the frequency domain. FIG. 4a depicts an electrical excitation signal 350 comprising a plurality or band of frequencies in the time domain, and FIG. 4b is the equivalent signal amplitude representation in the frequency domain.

In one embodiment the signal generator 300 generates such an electrical excitation signal 350 by using the frequency mixer 330 to mix a bandlimited signal 360 provided by the baseband signal generator 310 with a band centre signal 370 provided by the carrier signal generator 320. The baseband signal generator 310 receives a signal 380 indicative of the desired bandwidth of the baseband signal 360 to be generated.

The baseband signal generator 310 may either be a signal generator that generates the signal in real time based on and as required by the signal 380 indicating the required bandwidth or may read pre-generated baseband signals 360 from a memory comprised within the baseband signal generator 310. It will be appreciated that, in the latter case the memory stores multiple different baseband signals to allow the selection of a baseband signal that meets the bandwidth requirements stipulated by the signal 380. The memory may in particular be a read only memory (ROM) which stores a series of sample amplitude values. Reading the sample amplitude values saved in the memory of the baseband signal generator 310 generates a bandlimited signal 360 in the form of a discrete time piecewise step function. In the frequency domain, the bandlimited signal comprises a continuous band of frequencies with substantially constant amplitude, and substantially no frequency components outside the frequency band. The baseband signal 360 may be centered on OHz within the frequency domain.

The baseband signal 360 may be defined in the time domain by the product of a sinc function and a window function, such as a rectangular, Hann, Hamming, Blackman or Kaiser window function, or another suitable window function, which limits the duration of the baseband signal 360 within the time domain. The sinc function may oscillate at a cutoff frequency equal to half the bandwidth of the baseband signal 360 in the frequency domain.

The carrier signal generator 320 receives a signal 390 indicative of a desired centre frequency for the excitation signal 350 and generates a sinusoidal carrier signal 370 in the time domain having this desired (single) centre frequency. The signal 380 and/or the signal 390 may be received from electronics unit 150 of the anemometer 100 described with reference to FIG. 1.

The baseband signal 360 and the carrier signal 370 are mixed by the mixer 330 to obtain a mixed signal . The mixed signal is in the form of higher frequency sinusoid within a lower frequency sinc function envelope within the time domain, and takes the form of a square function in the frequency domain, having a frequency band of width equal to that of the baseband signal 360 and centred on the frequency of the carrier signal 370.

The mixed signal is fed to a modulator 340. The modulator 340 converts the (digital) mixed signal into its analogue equivalent using a digital to analogue converter or any other suitable modulation technique such as PWM. The modulator may additionally but optionally normalise the mixed signal before its conversion into the analogue signal, such that the digital signal’s maximum amplitude lies within the maximum analogue dynamic range that can be accommodated by the modulator 340.

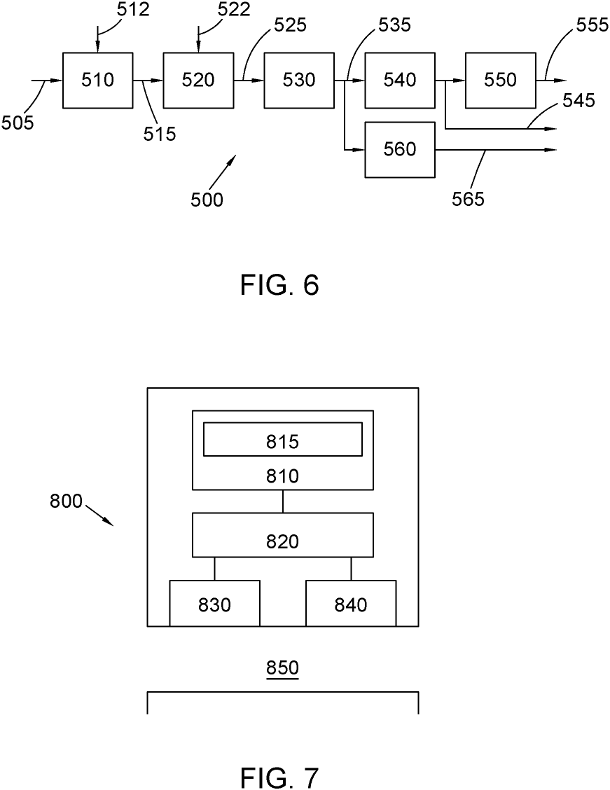

FIG. 6 is a diagram of a signal processing means 500 for analysing electrical response signals into which acoustic response signals within an acoustic resonance cavity are converted by an electro-acoustic transducer, such as one of the electro-acoustic transducers 140, 141, 142 of the anemometer 100 described above with reference to FIGS. 1a and 1b. The signal processing means 500 may be made part of the control unit 150 of such an anemometer 100.

The signal processing means 500 comprises an analogue to digital converter 510, optionally an averaging module 520, a frequency spectrum calculation means 530, a resonant frequency calculation means 540, a phase calculation means 550 and a signal to noise ratio estimation means 560.

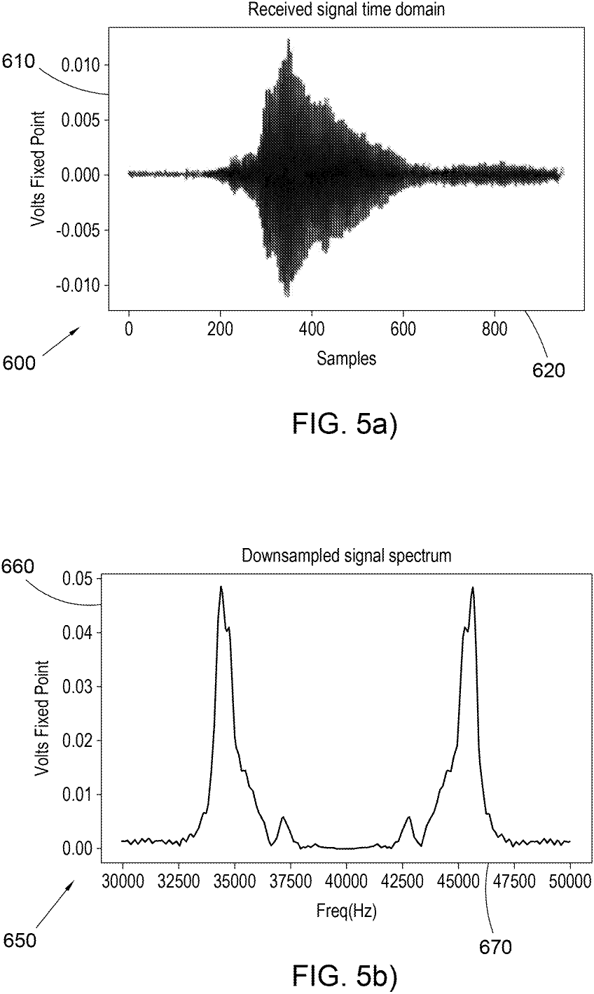

The signal processing means 500 is configured to analyse electrical response signals comprising a plurality or band of frequencies, such as those generated in order to identify a resonant frequency of an acoustic resonance cavity. FIG. 5a depicts an electrical response signal 505 comprising a plurality or band of frequencies in the time domain, and FIG. 5b is the equivalent signal amplitude representation in the frequency domain.

The signal processing means 500 is configured to obtain a frequency spectrum 535 of an electrical response signal 505 and to identify a peak of the frequency spectrum 535, determining that the signal to noise ratio 565 of the peak is sufficient for the peak to be identified as a resonant frequency 545. If the SNR is sufficient then the phase 555 or group delay of the signal 505 at the resonance frequency 545 is determined.

The analogue to digital converter (ADC) 510 converts analogue electrical response signals 505 produced by one of the electro-acoustic transducers 140, 141, 142 of the anemometer 100 described above with reference to FIGS. 1a) to 1c) into digital response signals 515 based on a sampling rate 512 provided by a control means which may, for example, be part of the electronics unit 150 of an anemometer 100 as described above with reference to FIGS. 1a) to 1c).

An averaging module 520 may optionally be provided that averages a number of digital response signals 515 and outputs an averaged digital response signal 525 with improved signal to noise ratio. An averaging factor 522 is provided to the averaging module 520 by the electronics unit 150, determining the number of digital response signals 515 to be averaged. All or part of this frequency spectrum 535 is calculated by a frequency spectrum calculation means 530, for example, by calculating a Fourier transform (e.g. using an FFT, a discrete Fourier transform, a short time Fourier Transform (STFT) or the Goertzel algorithm) of the digital response signal 515, or the averaged digital response signal 525. Alternatively, the frequency spectrum may be obtained using other transforms, such as the Laplace or Z-transforms or other time-domain to frequency-domain transformation methods.

The resonant frequency calculation means 540 identifies the frequency with the maximum amplitude within the frequency spectrum 535. In one embodiment the signal to noise ratio calculation means 560 compares the amplitude of the peak detected by the resonant frequency calculation means 540 to the noise level of the frequency spectrum in order to calculate the signal to noise ratio 565 of the peak. If the signal to noise ratio 565 exceeds a predetermined threshold, the frequency of the peak is determined to be a resonant frequency 545 of the acoustic resonance cavity. The threshold may be stored in a memory of the device 500. It is envisaged that signal quality criteria other than the signal to noise ratio may be used as effectively for comparison with the threshold discussed herein to ascertain the adequacy of the signal.

An anemometer comprising the signal processing means subsequently performs fluid velocity calculations at that resonant frequency. The anemometer may be an anemometer 100 according the embodiment described above and the fluid velocity measurements may be performed as described above with reference to FIGS. 1a) to 1c). Such fluid velocity calculations comprise calculation of the differential phase shifts or group delays that occur between transducer pairs as previously described.

If the signal to noise ratio 565 does not exceed the resonant frequency identification threshold, this may indicate that the accuracy or resolution of the frequency spectrum is not sufficient to determine whether the identified peak is at a resonant frequency, or that the band of frequencies comprised by the frequency spectrum 535 does not include any resonant frequencies. These two situations may be differentiated by additionally comparing the signal to noise ratio to a resonant frequency absence threshold that is lower than the resonant frequency detection threshold.

In the event that the signal to noise ratio 565 does not exceed the threshold and no resonant frequency 545 is identified, the frequency spectrum 535 may be determined to include no resonant frequencies and the steps of the method are repeated with a different acoustic signal comprising a different band of frequencies. This may allow the frequency of an identified peak to be determined with greater accuracy, or allow frequencies outside the originally measured band to be searched for resonant frequencies. The steps of the method may be repeated multiple times until a signal to noise ratio exceeds the threshold.

In some embodiments, in the event that the signal to noise ratio 565 does not exceed the threshold, but does exceed a lower resonant frequency absence threshold, the steps of the method are repeated with a new acoustic signal. To improve the accuracy of the repeated measurement, the new acoustic signal comprises a frequency band with a narrower bandwidth than the bandwidth of the preceding acoustic signal. This frequency band overlaps with or is even centred on the same centre frequency as the previously used frequency band. In an embodiment the frequency band is centred on a peak identified in the previously acquired frequency spectrum 535. The power of the new acoustic signal remains the same as the preceding acoustic signal. The amplitudes in the band of frequencies of the new signal are consequently higher than those of the preceding signal. This increase in the amplitude of the emitted frequencies increases the amplitude of non-noise components of the electrical excitation signal, thereby increasing the signal to noise ratio 565.

If the frequency of the peak is determined to be a resonant frequency 545 of the acoustic resonance cavity the phase calculation means 550 calculates the phase or group delay of the of the digital response signal 515, or the averaged digital response signal 525.

The phase or group delay at a resonant frequency, and the resonant frequency itself may be used to calculate the wind speed along an axis between the point from which the acoustic signal was emitted and the point at which the acoustic wave was received. This is described in detail in aforementioned EP0801311, the entirety of which is incorporated herein by reference.

FIG. 7 is a diagram of an acoustic resonance fluid flow sensor 800 configured to perform a method as described above, such as the method 200 of FIG. 2. The acoustic resonance fluid flow sensor 800 comprises a storage means 810, a processing means 820, a signal emission means 830 and a signal reception and processing means 840.

The storage means 810 is communicatively connected to the processing means 820 and comprises computer instructions 815 that are executable by the processing means 820 to cause the processing means 820 to perform the method.

The processing means 820 is also communicatively connected to the signal emission means 830 and the signal reception and processing means 840 and is configured to control the signal emission means 830 and the signal reception and processing means 840 under the computer instructions 815 to perform steps of the method.

The signal emission means 830 is configured to emit an acoustic stimulus signal into an acoustic resonance cavity 850 (part of the sensor 800) under control of the processing means 820, thereby exciting an acoustic wave within the acoustic resonance cavity 850. The signal emission means 830 may comprise or use an electro-acoustic transducer and may comprise features or components of the signal generator 300 described above with reference to FIG. 3.

The signal reception and processing means 840 is configured to receive and process an acoustic response signal within the acoustic resonance cavity 850 under control of the processing means 820. The signal reception and processing means 840 may comprise or use an electro-acoustic transducer and may comprise features or components of the signal processing means 500 described above with reference to FIG. 6.

The computer instructions 815, when executed by the processing means 820, cause the processor 820 to control the signal emission means 830 to emit an acoustic stimulus signal comprising a plurality or band of frequencies into the acoustic resonance cavity 850 thereby generating an acoustic wave within the acoustic resonance cavity 850. The executed computer instructions 815 further cause the processor 820 to control the signal reception and processing means 840 to receive and process an acoustic response signal derived from the acoustic wave. The executed computer instructions 815 further cause the processing means 820 to identify a frequency of a peak of a frequency spectrum of the acoustic response signal, and/or to calculate the phase of one or more frequencies of the frequency spectrum of the acoustic response signal. The computer instructions 815 may also be configured to cause the processing means 820 to perform any of the other steps of the method described above.

The signal generator, signal processing means, processor and/or control means described in any of the above embodiments may be furnised by one or more microprocessors, microcontrollers, digital signal processors (DSPs), field-programmable gate arrays (FPGAs), complex programmable logic devices (CPLDs), other programmable logic devices, and/or application specific integrated circuit (ASIC) implementations. The signal generator, signal processing means, processor and/or control means may be defined by multiple devices as listed above. In some such embodiments some blocks may be integrated on a microprocessor and others on custom logic.

The invention has been described by way of example only, and it will be appreciated that variation may be made to the embodiments described above without departing from the scope of the claims.

1. A method of identifying a resonant frequency of an acoustic resonance fluid flow sensor, the method comprising:
emitting an acoustic stimulus signal comprising a plurality of frequencies into an acoustic resonance cavity of the acoustic resonance fluid flow sensor;
sensing an acoustic response signal within the acoustic resonance cavity;
identifying a frequency of a peak in a frequency spectrum of the sensed acoustic response signal;
deriving a phase or group delay of the sensed acoustic response signal at the identified frequency of the peak; and
determining a speed of fluid flow through the sensor based on the derived phase or group delay.

2. A method according to claim 1, wherein the plurality of frequencies are a band of frequencies.

3. A method according to claim 2, wherein the band of frequencies is a continuous band of frequencies of substantially constant amplitudes, and wherein the acoustic signal comprises substantially no frequencies outside the band.

4. A method according to claim 2, wherein emitting the acoustic stimulus signal comprises generating an electrical excitation signal and converting the electrical excitation signal into the acoustic stimulus signal using an electro-acoustic transducer, and wherein generating the electrical excitation signal comprises using a frequency mixer to mix a signal that comprises a band of frequencies having a selected bandwidth and a carrier signal that comprises a single selected frequency.

5. A method according to claim 4, wherein the signal comprising the band of frequencies comprises a rectangular frequency spectrum.

6. A method according to claim 5, wherein the signal comprising the band of frequencies is defined in the time domain by a sinc function multiplied by a window function.

7. A method according to claim 4, further comprising generating the signal comprising the band of frequencies by reading out amplitude values from a memory.

8. A method according to claim 1, further comprising determining whether a parameter of a signal quality of the sensed acoustic response signal exceeds a predetermined threshold.

9. A method according to claim 8, further comprising: if the parameter of the signal quality does not exceed the predetermined threshold, repeating the steps of the method with the acoustic stimulus signal comprising a different plurality of frequencies.

10. A method according to claim 8, further comprising: if the parameter of a signal quality does not exceed the predetermined threshold, repeating the steps of the method and, prior to said identifying for said deriving, averaging a plurality of acoustic response signals to form an averaged acoustic response signal and identifying said frequency or deriving said phases or group delays based on the averaged acoustic response signal.

11. A method according to claim 1, wherein
the acoustic stimulus signal comprising the plurality of frequencies is a first acoustic stimulus signal emitted by a first transducer, and
the acoustic response signal is a first acoustic response signal that is sensed using a second transducer, and
further comprising:
emitting a second acoustic stimulus signal comprising the plurality of frequencies into the acoustic resonance cavity using the second transducer;
sensing a second acoustic response signal using the first transducer;
deriving a phase or group delay of the sensed second acoustic response signal at the identified frequency of the peak,
determining a difference between the phase or group delays derived based on the second acoustic response signal and a phase or group delays derived based on the first acoustic response signal, and
determining a speed of fluid flow within the acoustic resonance cavity along an axis between the first and second using the determined difference.

12. An acoustic resonance fluid flow sensor comprising:
an acoustic resonance cavity;
a first transducer configured to emit an acoustic stimulus signal comprising a plurality of frequencies into the acoustic resonance cavity;
a second transducer configured to sense an acoustic response signal within the acoustic resonance cavity; and
a signal processing means configured to: identify a frequency of a peak in a frequency spectrum of the sensed acoustic response signal, derive a phase or group delay of the sensed acoustic response signal at the identified frequency of the peak; and determine a speed of fluid flow through the sensor based on the derived phase or group delay.

13. One or more storage media comprising computer instructions executable by one or more hardware processors for causing the one or more hardware processors to perform the steps of:
emitting an acoustic stimulus signal comprising a plurality of frequencies into an acoustic resonance cavity of the acoustic resonance fluid flow sensor;
sensing an acoustic response signal within the acoustic resonance cavity;
identifying a frequency of a peak in a frequency spectrum of the sensed acoustic response signal;
deriving a phase or group delay of the sensed acoustic response signal at the identified frequency of the peak; and
determining a speed of fluid flow through the sensor based on the derived phase or group delay.
